(19) United States
(12) Patent Application Publication
(10) Pub. No.: US 2009/0161698 A1
(43) Pub. Date: Jun. 25, 2009

(54) METHOD AND APPARATUS FOR DATA PROCESSING

(75) Inventor: Isao CHIKU, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/338,700

(22) Filed: Dec. 18, 2008

(30) Foreign Application Priority Data
Dec. 19, 2007 (JP) 2007-327428

(51) Int. Cl. H04J 3/02

(52) U.S. Cl. 370/542

(57) ABSTRACT

A data processing apparatus, having an overhead branching unit configured to branch a signal data into an overhead and signal data; a control unit configured to retain the overhead; a time slot interchange unit configured to perform time slot interchange on the signal data; and an overhead insertion unit configured to insert the signal data and the overhead output from the time slot interchange unit and outputting as signal data.

### CROSS-REFERENCE TO RELATED APPLICATION

This application is based upon and claims the benefit of priority of the prior Japanese Patent Application No. 2007-327428, filed on Dec. 19, 2007, the entire contents of which are incorporated herein by reference.

### BACKGROUND

The present invention relates to a method and an apparatus for channel switching, and may include a method and an apparatus for channel switching (line switching) in a SONET/SDH frame digital synchronous network by using a time slot interchange unit.

In a SONET/SDH (SONET) based synchronous digital communication network, a channel switching apparatus is used that switches between channels temporally by time slot interchange in a digitally-multiplexed state. FIG. 12 is a diagram showing the channel switching apparatus for switching between channels temporally, in which a time slot interchange unit inputs overheads (SOH/LOH) of a SONET frame along with time slot interchange.

The channel switching apparatus shown in FIG. 12 includes time slot interchange units ITC for time slot interchange (TSI), and switches channels of 35 Gb/s optical signals between dual systems. An opto-electric converting unit O/E converts an input optical signal into an electric signal, converts the signal in parallel into data of 1.2 Gb/s, which is a speed corresponding to internal processing, and sends the result to a demultiplexer DMUX. The demultiplexer DMUX demultiplexes the received data into data of 77.76 Mb/s, which is a speed for each channel (or port), and sends the data to the time slot interchange units ITC.

A time slot interchange unit ITC performs time slot interchange on data of each channel and sends data at the same speed of 77.76 Mb/s to multiplexers MUX. A multiplexer MUX multiplexes the data of each channel to restore the data to 1.2 Gb/s data. An electro-optical converting unit E/O further multiplexes the data to 35 Gb/s data, converts the data into an optical signal and then outputs the signal.

FIG. 13 shows a configuration in which the channel switching apparatus shown in FIG. 12 is applied to an STS switch fabric. In the STS switch fabric shown in FIG. 13, the two-system optical signals shown in FIG. 12 are input to an upper port UP and a lower port LP in parts. Each port includes a time slot interchange unit ITC and interface units IFU (r) and (s) (including both a receiver (r) and a sender (s)) indicating the other portions.

In FIG. 13, each interface unit IFU has 40 input ports and 40 output ports. With the input/output ports, the capacity for an input signal is 35 Gb/s and the capacity for an output signal is also 35 Gb/s in each of the upper port UP and the lower port LP, as shown also in FIG. 12.

FIGS. 14 to 17 show frame formats of an STS signal input to the STS switch fabric shown in FIG. 13: FIG. 14 shows an STS-3 frame format (155.52 Mb/s); FIG. 15 shows an STS-12 frame format (622.08 Mb/s); FIG. 16 shows an STS-24 frame format (1244.16 Mb/S=1.24416 Gb/s); and FIG. 17 shows an STS-48 frame format (2488.32 Mb/S=2.48832 Gb/s).

FIG. 18 shows a configuration of the conventional channel switching apparatus shown in FIGS. 12 and 13. However, the opto-electric converting units O/E and the electro-optical converting units E/O shown in FIG. 12 are omitted in FIG. 18.

In FIG. 18, the apparatus includes receiving interface units IFr#1 to IFr#n (IFr), receiving format converting units FCr#1 to FCr#n (FCr), time slot interchange units ITC#1 and ITC#2 (ITC), sending format converting units FCs#1 to FCs#n (FCs), and sending interface units IFs#1 to IFs#n (hereinafter, represented by symbols IFs) provided for total of n channels.

In FIG. 18, the interface units IFr and the format converting units FCr operate as the demultiplexers DMUX shown in FIG. 12, while the format converting units FCs and the interface units IFs operate as the multiplexers MUX. A counter CTR4 is further provided that is connected between the control unit CNT for controlling each unit and the time slot interchange units ITC#1 and ITC#2.

FIGS. 19A and 19B are a timing chart illustrating the operation of the conventional channel switching apparatus shown in FIG. 18.

First, line data (5) of a SONET frame (primary signal data output from an opto-electric converting unit O/E shown in FIG. 12) is input to a clock data recovery unit CDRr provided in the interface unit IFr#1, which extracts a clock (4). Then, data recovered by the clock data recovery unit CDRr is subjected to serial-parallel conversion by a serial-parallel converting unit S/P and demultiplexed into parallel data (6) for n channels. The channel data (6) is sent to the synchronization units SYNC#1 to SYNC#n (SYNC) provided in the respective interface units IFr#1 to IFr#n.

When each synchronization unit SYNC finds the head of a frame by detecting a frame synchronization signal in the channel data (6) (A1 byte and A2 byte in an overhead region), each synchronization unit SYNC outputs data (7). The data (7) is sent to the memories ES#1 to ES#n (ES) provided in the respective channels and retained on the clock (4) timing.

The interface units IFr#1 to IFr#n have counters CTR1#1 to CTR1#n (CTR1), respectively. The respective counters CTR1 generate timing signals (9), (11) to (13) synchronized with a timing pulse (1) and a master clock (3). The memories ES, which receive the timing signals, align the heads and reattach the master clock (3) of the retained data (7) according to the timing signals (9), and output the results as data (8), (10) to (12) to the format converting units FCr#1 to FCr#n.

The format converting units FCr#1 to FCr#n comprise alarm insertion units ALMINS#1 to ALMINS#n (ALMINS), respectively. The respective alarm insertion units ALMINS attach alarm information ALM such as “lost synchronization, AIS, disconnection” in the data (8), (10) to (12) detected by the synchronization units SYNC of the interface units IFr to unused bytes of overheads (SOH/LOH) of the data (8), (10) to (12) and output the results as data (8-1), (10-1) to (12-1).

In the format converting units FCr, the alarm insertion units ALMINS#1 to ALMINS#n connect to the dynamic random access memories (DRAMs) DRAM1#1 to DRAM1#n, respectively. The data (8-1), (10-1) to (12-1) is written at corresponding addresses in the DRAM1 depending on write address signals (14) to (17) generated by the counters CTR2#1 to CTR2#n (CTR2) based on the master clock (3) and timing signals from the counters CTR1#1 to CTR1#n (corresponding to the timing signals (9)).

Herein, the head positions of the data (8-1), (10-1) to (12-1) input to the DRAM1 are not uniform since the respective interface units IFr take different routes. For read ports of the

DRAM1 to make all the head positions uniform, read address signals (15) to (18) are used that are generated by counters CTR3#1 to CTR3#n (CTR3) based on the master clock (3) and the timing pulse (1). At the read ports of the DRAM1, 8-bit data (16) to (19) is read out in the read address signals (15) to (18), each of the data is branched into four-bit unities and input to the time slot interchange units ITC#1 and ITC#2.

The counter CTR4 is provided between the time slot interchange units ITC#1 and ITC#2. It generates a count signal (20) for the respective units (SC1#1, SC1#2; SW#1, SW#2; TSI#1, TSI#2; BRD#1, BRD#2; SC2#1, SC2#2) of the time slot interchange units ITC#1 and ITC#2 according to the timing pulse (1) and the master clock (3) and overhead branching units OHDRP#1 and OHDRP#2. In FIGS. 19A and 19B, the count signal is a 1/9720 frequency division signal according to the frame length.

The time slot interchange units ITC perform time switching using the count signal (20) from the counter CTR4, a control signal from the control unit CNT, and the alarm information ALM branched by the overhead branching units OHDRP#1 and OHDRP#2, and output four-bit data (21).

The time slot interchange units ITC#1 and ITC#2 handle data before and after the switching in a same time slot. For this purpose, the operation speed needs to be twice as fast, so that the data amount is reduced to half and two time slot interchange units are provided for a single ITC to achieve the desired speed. By this configuration, only one time slot interchange unit is enough for the operation to achieve the double speed.

The output data (21) of the time slot interchange units ITC is sent to the format converting units FCs#1 to FCs#n (FCs) for the respective channels. In the respective format converting units FCs, multiplexers MUX#1 to MUX#n multiplex the data (21) sent from the dual-system time slot interchange units ITC#1 and ITC#2 and write the data in the DRAM2#1 to DRAM2#2 (DRAM2). Write address signals (22) are generated by counters CTR5#1 to CTR5#n (CTR5) based on the timing pulse (1) and a timing pulse (27) from the counter CTR4.

Then, counters CTR6#1 to CTR6#n (CTR6), which receive a line clock generated by a clock data recovery unit CDRs, generate a read address signal (23), provide the signal to the DRAM2#1 to DRAM2#n to read out data (24) and output the data to interface units IFs#1 to IFs#n.

Overhead (SOH/LOH) insertion units (OHINS#1 to OHINS#n: OHINS) of the interface units IFs insert overhead information (output at rewriting) from the control unit CNT into the data (24) to produce data (25). A parallel-serial converting unit P/S unit performs parallel-serial conversion on the data (25) for each channel and outputs the result to the clock data recovery unit CDRs. The clock data recovery unit CDRs performs level conversion on the data to produce line data (26) and outputs the data (26).

Japanese Patent Laid-Open No. 11-243391 discloses an ATM cell data receiving/transmitting system for using one byte used for header error control (HEC) for cell overhead information (OH), and processing a cell as 53 bytes being the same number of bytes as a transmission path cell. According to this configuration, the number of cells in a frame is the same as that of a transmission path, stuff and destuff control is dispensed with, and cell overhead information can be used for switching, thereby enabling fast switching processing.

Japanese Patent Laid-Open No. 2000-307536 discloses a channel selection method including: processing overhead information by inputting a SONET OC-n signal to a receive line terminating apparatus; demultiplexing a synchronous transfer path signal for each synchronous transfer signal path; performing cross-connection according to map information from an apparatus management control unit by a cross connect unit; inputting the signal to a transmit line terminating apparatus; adding overhead information for each sent signal level; and outputting the SONET OC-n signal. In the channel selection method, if a synchronous transfer path signal demultiplexed by the receive line terminating apparatus no longer synchronizes with a clock in a SONET, then a synchronous transfer path channel selection unit performs selection according to a selected signal from the apparatus management control unit, and a PJC count unit counts and generates a PJC parameter.

FIG. 20 is a diagram showing a flow of a SONET frame format in the prior art shown in FIG. 18. In the drawing, the output data (8) of a memory ES, the output data (16) of the DRAM1, the output data (21) of a time slot interchange unit ITC, and the output data (25) of an overhead insertion unit OHINS are output without converting a data format of an input SONET frame, but with interchanging a time slot. That is, the same master clock (3) controls from the interface units IFr to interface units IFs in the channel switching apparatus shown in FIG. 20.

A highly efficient transmission scheme with flexible line combination will be desired for speeding up the transmission and increasing capacity in the future. As such, for a channel switch apparatus, an increased number of line combinations may be expected for the increase of a circuit size and the increase in the number of channels. To fulfill such requests with the conventional channel switch schemes shown in FIGS. 18 to 20, the number of wires becomes enormous, inducing a problem of insufficient timing margins in layout of an integrated circuit, or a problem of impossible layout of an integrated circuit.

When downsizing an apparatus by capturing and integrating divided functions into one LSI with the LSI integration technologies that have remarkably developed in recent years, operation speed and circuit size constraints due to devices hamper the design of circuits to realize desired functions.

Specifically, when improving the degree of integration of a circuit, the most highly integrated time slot interchange unit (TSI) has a constraint on an operation speed, therefore it is difficult to operate the time slot interchange unit at the same clock speed as an interface unit. Accordingly, further dividing (Bit Slice) to decrease the operation speed of the time slot interchange unit may improve the problem of speed, but doing so increases a circuit size.

Moreover, the time slot interchange unit performs the TSI processing on all data including the overhead, thereby improving the operating efficiency in bit change of a digital signal but increasing power consumption.

### SUMMARY

A data processing apparatus, having an overhead branching unit configured to branch a signal data into an overhead and signal data; a control unit configured to retain the overhead; a time slot interchange unit configured to perform time slot interchange on the signal data;and an overhead insertion unit configured to insert the signal data and the overhead output from the time slot interchange unit and outputting as signal data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram showing a channel switching apparatus according to an embodiment;

FIGS. 2A and 2B are a timing chart of the channel switching apparatus according to an embodiment;

FIG. 3 is a flow diagram of a frame format of the channel switching apparatus according to an embodiment;

FIG. 4 is a block diagram showing a channel switching apparatus according to an embodiment;

FIG. 5 is a block diagram showing a channel switching apparatus according to an embodiment;

FIG. 6 is a block diagram showing a channel switching apparatus according to an embodiment;

FIGS. 7A and 7B are a timing chart of a channel switching apparatus according to an embodiment;

FIG. 8 is a flow diagram of a frame format of a channel switching apparatus according to an embodiment;

FIG. 9 is a block diagram showing a channel switching apparatus according to an embodiment;

FIG. 10 is a block diagram showing a channel switching apparatus according to an embodiment;

FIG. 11 is a block diagram in which the present invention is applied to an STS switch fabric;

FIG. 12 is a block diagram showing the configuration of a channel switching apparatus;

FIG. 13 is a block diagram of an application of the channel switching apparatus shown in FIG. 12 to an STS switch fabric;

FIG. 14 is a format diagram of an STS-3 frame;

FIG. 15 is a format diagram of an STS-12 frame;

FIG. 16 is a format diagram of an STS-24 frame;

FIG. 17 is a format diagram of an STS-48 frame;

FIG. 18 is a block diagram showing a method and an apparatus for channel switching according to a prior art;

FIGS. 19A and 19B are a timing chart showing the method and the apparatus for channel switching according to the prior art; and

FIG. 20 is a flow diagram of a frame format in the method and the apparatus for channel switching according to the prior art.

### DETAILED DESCRIPTION OF THE PREFERRED EMBODIMENTS

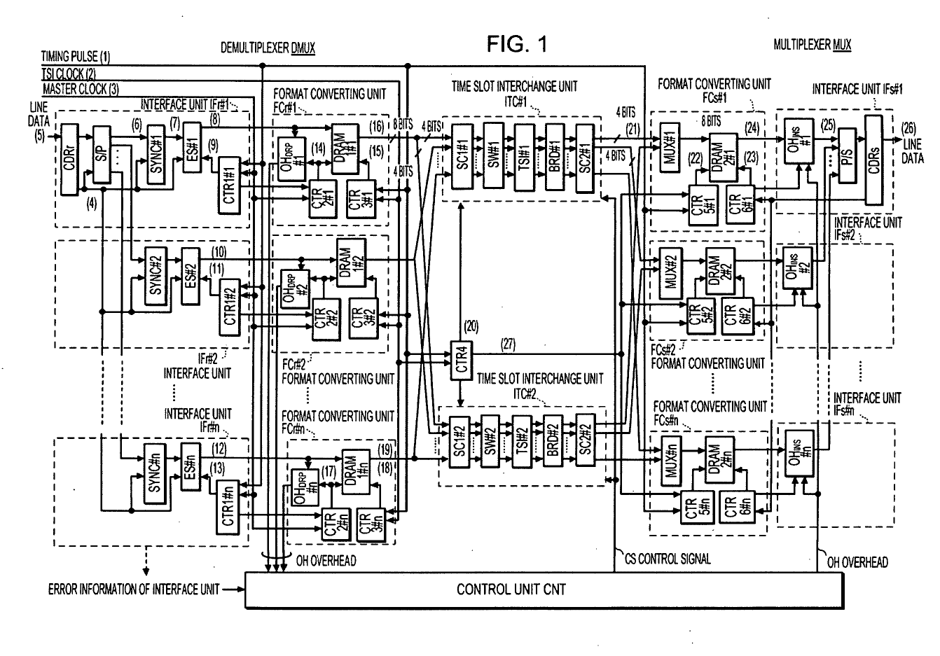

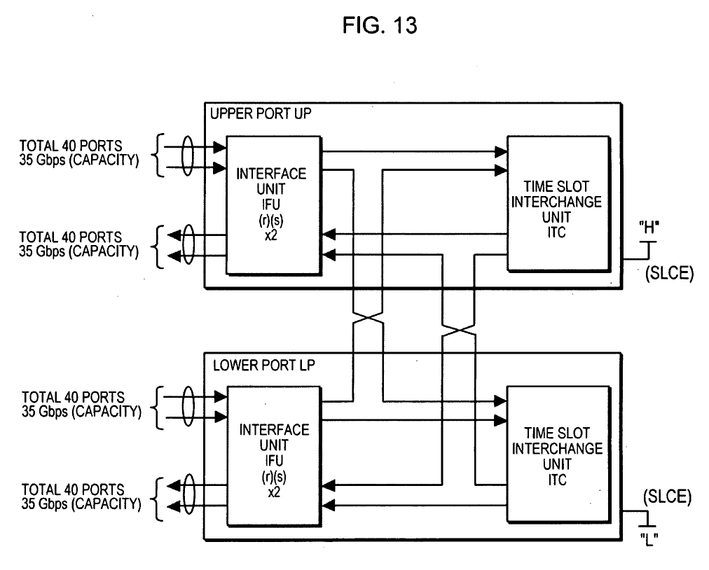

FIG. 1 is a block diagram showing a channel switching apparatus according to an embodiment. In the channel switching apparatus shown in FIG. 1, interface units IFr (IFr#1 to IFr#n) and IFs (IFs#1 to IFs#n), time slot interchange units ITC (ITC#1 and ITC#2) are configured similarly as shown in FIG. 13.

In format converting units FCr (FCr#1 to FCr#n), output the data (8), (10) to (12) of memories ES in interface units IFr are sent to DRAM1 (DRAM1#1 to DRAM1#n). This differs from the configuration in FIG. 13 in which alarm insertion units ALMINS (ALMINS#1 to ALMINS#n) are used for the format converting units FCr (FCr#1 to FCr#n). The channel data (8), (10) to (12) are provided to overhead branching units OHDRP#1 to OHDRP#n (OHDRP), which extract and send overheads (SOH/LOH) to a control unit CNT.

For counters CTR3 (CTR3#1 to CTR3#n), a master clock (3) is not provided but a TSI clock (2) and a timing pulse (1) are provided. This differs from the configuration in FIG. 13 in which the counters CTR3 (CTR3#1 to CTR3#n) receive the master clock (3) and the timing pulse (1).

There is another difference from the configuration in FIG. 13 in a counter CTR4: the counter CTR4 is provided with the TSI clock (2) and the timing pulse (1) and outputs timing signals (20) and (27), while the counter CTR4 is provided with the master clock (3) and the timing pulse (1) in FIG. 13. The timing signals (20) and (27) are provided to the time slot interchange units ITC and counters CTR5 of format converting units FCs, so that the time slot interchange units ITC and the format converting units FCs operate according to the TSI clock (2). This differs from the configuration in FIG. 13 in which the time slot interchange units ITC and the format converting units FCs operate according to the master clock (3).

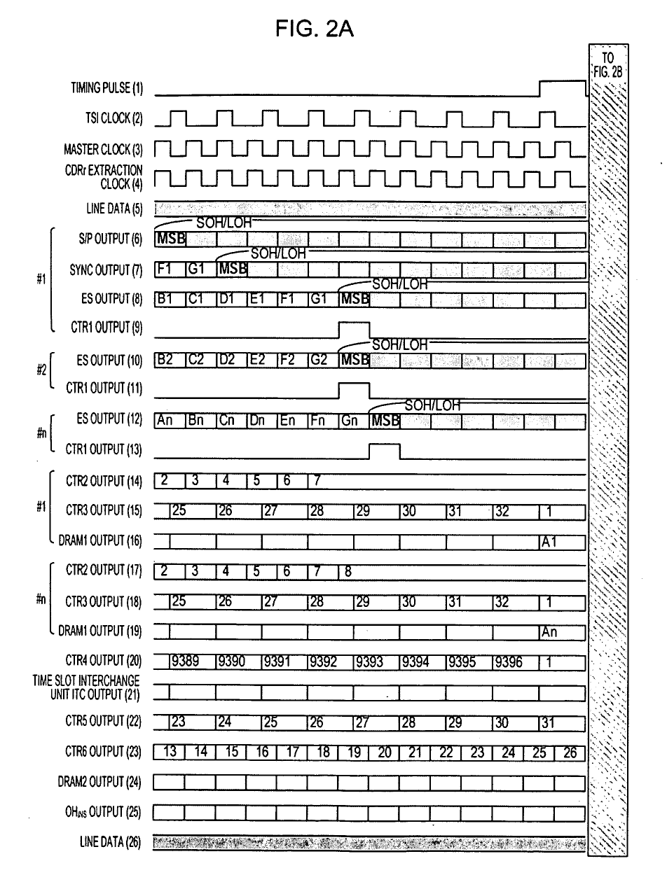

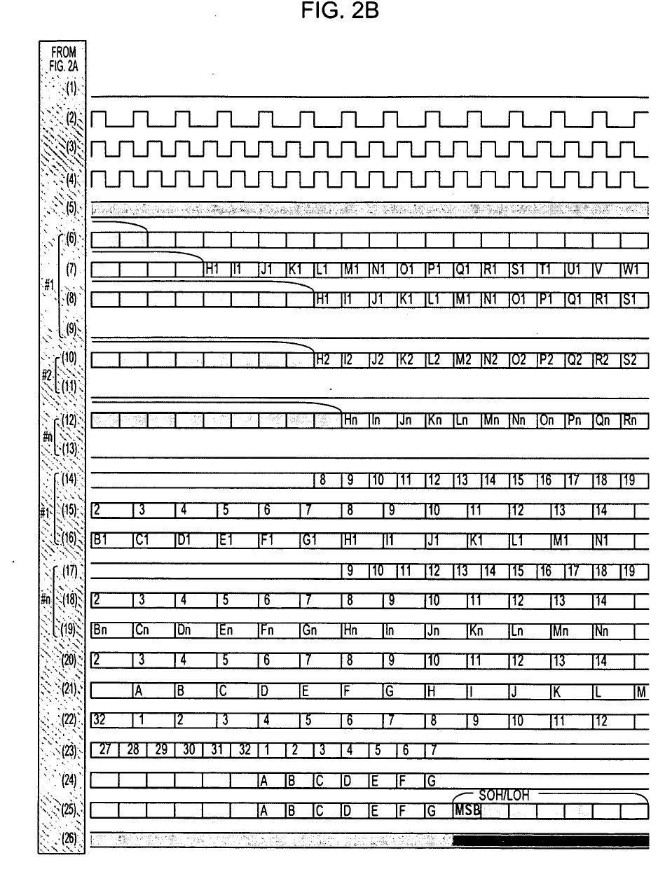

FIGS. 2A and 2B are a timing chart of the operation of the channel switching apparatus shown in FIG. 1.

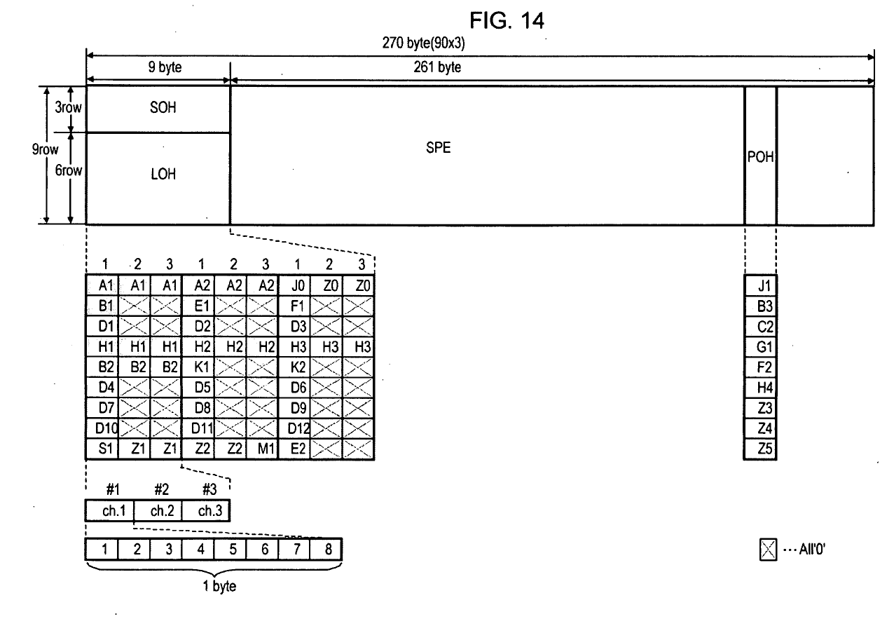

The operation of the interface units IFr in FIG. 1 is similar to the configuration shown in FIG. 13, so that data (5) to (13) are similar to the conventional timing chart shown in FIG. 14.

In a channel #1, when output data (8) from a memory ES#1 is sent to the DRAM1#1, the overhead branching unit OHDRP#1 extracts an overhead containing pointer data, extracts alarm information such as “lost synchronization, AIS, disconnection” detected by a synchronization unit SYNC#1 in an interface unit IFr#1 and outputs the extracted data to the control unit CNT.

The overhead branching unit OHDRP#2 to the overhead branching unit OHDRP#n (residing in the format converting unit FCr#2 to format converting unit FCr#n, respectively) similarly extract pointer data and alarm information from the data (10) to (12) and output the extracted data to the control unit CNT.

In the DRAM1#1, a write address signal (14) for the DRAM is generated by a counter CTR2#1, but overheads (SOH/LOH) of the output data (8) from the memory ES#1 are not written in the DRAM1#1. Similarly, the overheads are not written in the DRAM1#2 retaining the input data (10) in the format converting unit FCr#2, and overheads of the data (12) input to the format converting unit FCr#n are not written in the DRAM1#n.

As described in the above embodiment, the overheads in the data (8), (10) to (12) are not written in the DRAM1. This is because the counters CTR2 receive timing pulses from the counter CTR1 (corresponding to timing pulses (9), (11) to (13)), so that the counters CTR2 previously know the positions of the heads of the overheads when a count is counted up to “7” and stop the counting. The counters CTR2 also know when the ends of the overheads appear through subsequent counting by the master clock (3), so that they resume writing at a count “8”, as shown in FIGS. 2A and 2B.

The interface units IFr have different routes, so that head positions of data of all ports are made uniform through reading from the DRAM1. The counters CTR3 generate read address signals (15) to (18) for the DRAM1 using the TSI clock (2) and the timing pulse (1) and read out data (16) to (19) from the DRAM1.

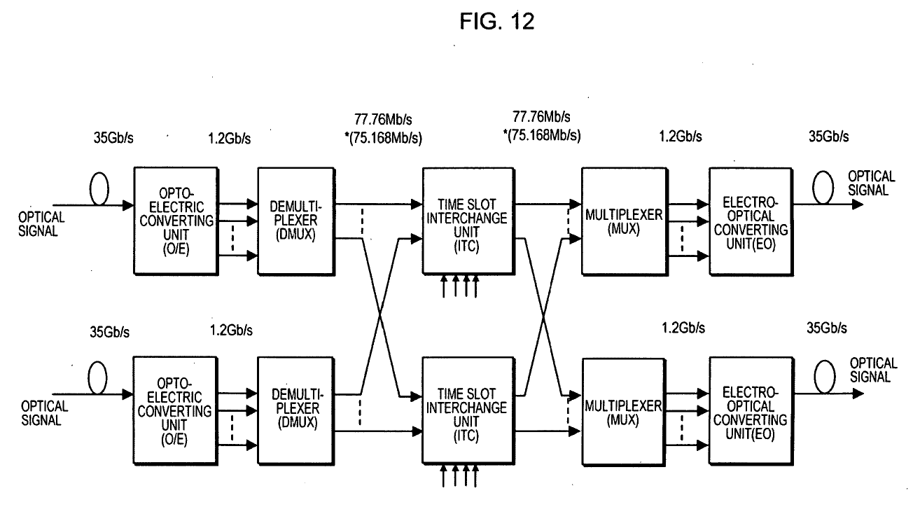

The counter CTR4 generates and provides a count signal (20) for time slot interchange units ITC#1 and ITC#2 according to the timing pulse (1) and the TSI clock (2). As in the configuration shown in FIG. 12, the signal is a 1/9396 frequency division signal according to the frame length. The time slot interchange units ITC#1 and ITC#2 perform time slot interchange using the count signal (20) from the counter CTR4 and a control signal CS from the control unit CNT, and the time slot interchange units ITC#1 and ITC#2 output data (21).

In the format converting units FCs, multiplexers MUX#1 to MUX#n multiplex the data (21) from the dual-system time slot interchange units ITC#1 and ITC#2, and 8-bit data is written in DRAM2. Meanwhile, a write address signal (22) for the DRAM2 is generated through receiving a clock signal (27) and the timing pulse (1) of the same speed as the TSI clock (2) from the counter CTR4 by the counter CTR5. A read address signal (23) for the DRAM2 is generated based on a line clock generated by counters CTR6 using a clock data recovery unit CDRs at a line data output. The DRAM2 read out data (24) according to the read address signal (23) and output the data (24) to overhead insertion units OHINS.

The overhead insertion units OHINS send data (25), which is gained by inserting data (24), such as overhead data, from the control unit CNT, to a parallel-serial converting unit P/S. The parallel-serial converting unit P/S performs parallel-serial conversion on the data (25) from the overhead insertion units OHINS#1 to OHINS#n and outputs the result to the clock data recovery unit CDRs. The clock data recovery unit CDRs performs level conversion on the data and outputs the result as line data (26).

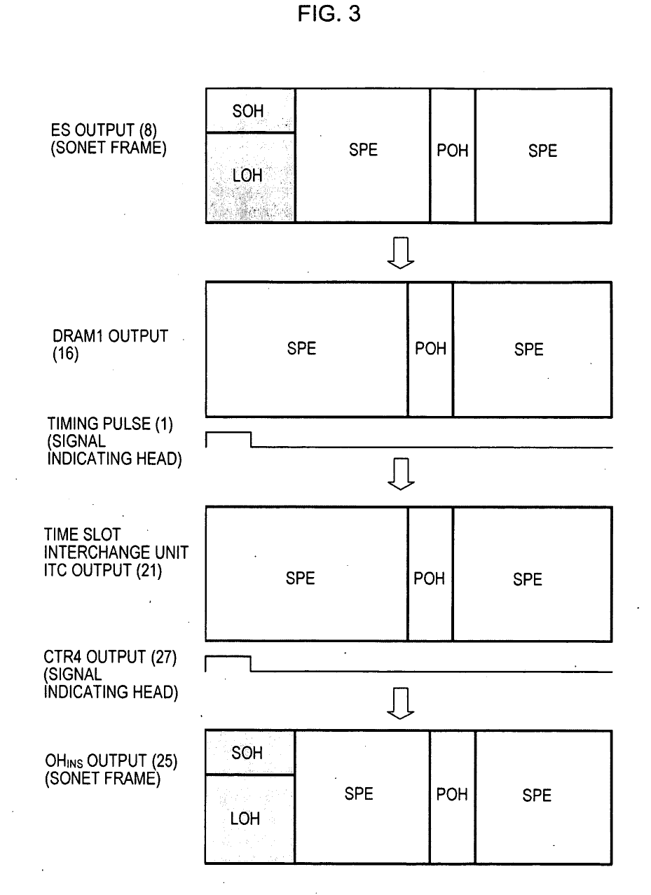

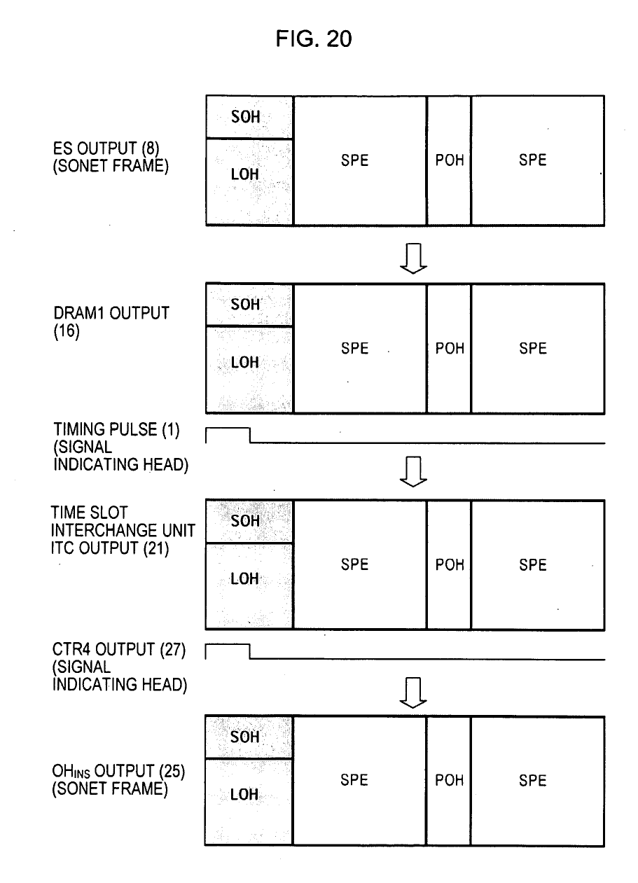

FIG. 3 is a diagram showing a flow of a SONET frame format. The output data (8) of the memories ES has a normal form of a SONET frame. However, when the data is stored in the DRAM1, overheads (SOH/LOH) of the data are removed. Accordingly, when the data is read out from the DRAM1 and processed in the time slot interchange units ITC, overheads of the data are deleted in the similar way. The processing speed in the time slot interchange units ITC is 76.168 Mb/s, which has been decreased from 77.76 Mb/s shown in the flow of a SONET frame format shown in FIG. 20. Then, the output data (25) of the overhead insertion unit OHINS is recovered to a normal SONET frame.

Specifically, the overheads (SOH/LOH) are deleted from data, which is to be input to a time slot interchange unit, of 9720 bits for a frame (77.76 MHz), making the data 9396 bits, which is divided evenly by frame periods so that a clock frequency is 75.168 MHz, thus reducing an operation clock of the time slot interchange unit by 0.966 times. That is, an internal operation speed is decreased, so that the power consumption can be reduced. Moreover, the decrease of operation speed can improve a timing margin by 443 ps.

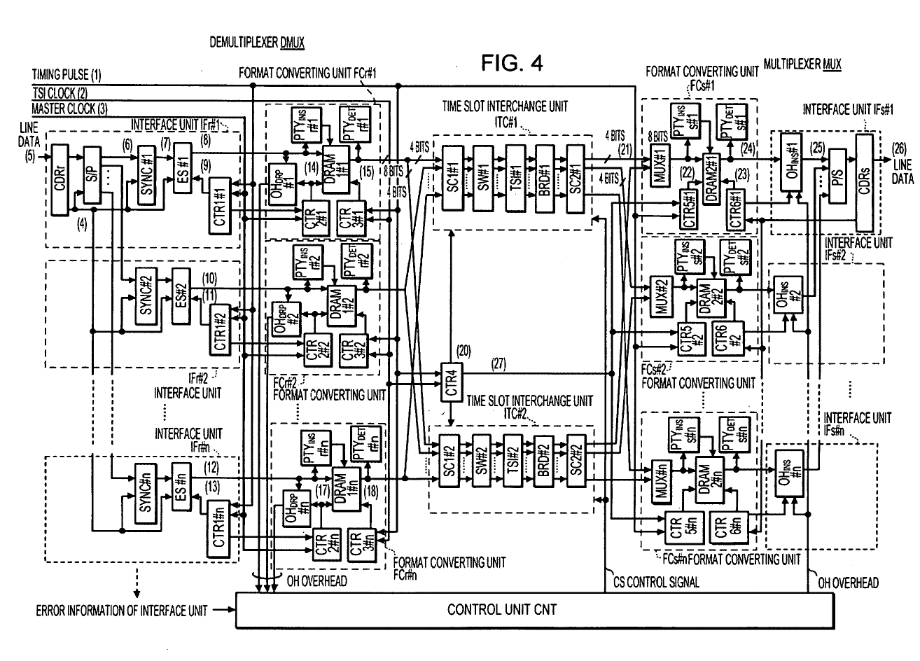

A channel switching apparatus shown in FIG. 4 has parity insertion units PTYINSr#1 to PTYINSr#n and parity error detection units PTYDETr#1 to PTYDETr#n in the format converting units FCr#1 to FCr#n, respectively, and includes parity insertion units PTYINSs#1 to PTYINSs#n and parity error detection units PTYDETs#1 to PTYDETs#n in format converting units FCs#1 to FCs#n, respectively. The other configuration is similar to the channel switching apparatus shown in FIG. 1.

In FIG. 4, the parity insertion units PTYINS generate parity of the DRAM1 and write the parity along with the data (8), (10) to (12) in the DRAM1, and the parity error detection units PTYDET detect parity errors of the output data (15) to (18) of the DRAM1 in the format converting units FCr.

Similarly, in the format converting units FCs, the parity insertion units PTYINS generate parity of the DRAM2 and the parity error detection units PTYDET detect parity errors. With this configuration, a parity error can be detected while the operation speed of the time slot interchange units ITC is decreased.

Through a fault diagnosis of a memory used for the format conversion, parts reliability and data reliability are improved, and the distribution of improper data to another slot in the time slot interchange by the time slot interchange unit may be controlled.

As well as the channel switching apparatus shown in FIG. 1, the operation of the channel switching apparatus shown in FIG. 4 is similar to the timing chart shown in FIGS. 2A and 2B, and the flow of a frame format by the channel switching apparatus shown in FIG. 4 is similar to the flow shown in FIG. 3.

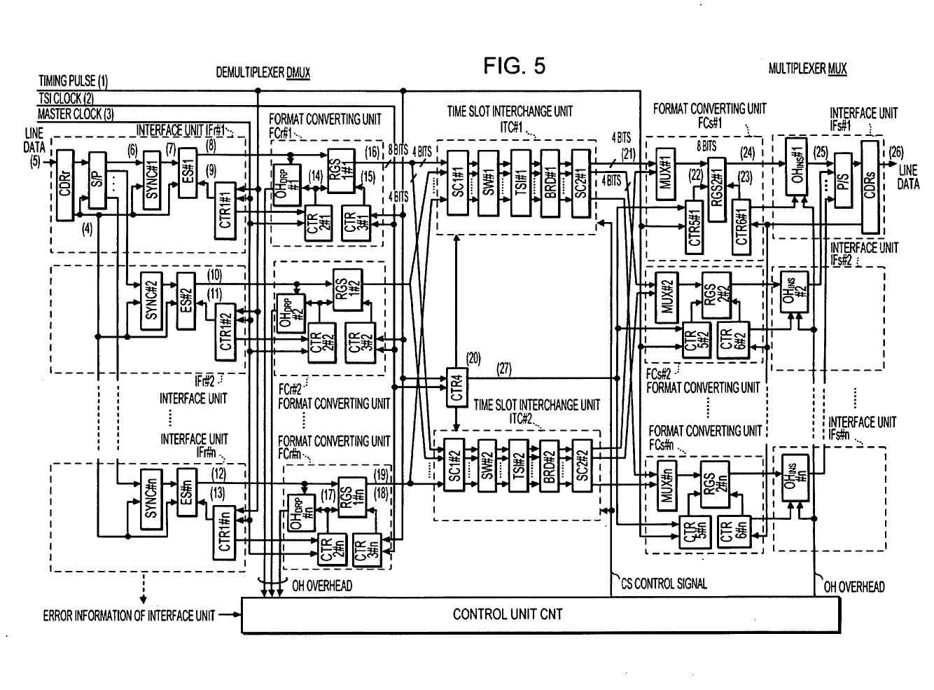

In a channel switching apparatus shown in FIG. 5, format converting units FCr comprise registers RGS1 (RGS1#1 to RGS1#n) and format converting units FCs comprise RGS2 (RGS2#1 to RGS2#n). The DRAM1 in the format converting units FCr of the channel switching apparatuses shown in FIGS. 1 and 4 correspond to the registers RGS1, and the DRAM2 in the format converting units FCs correspond to the RGS2.

If a DRAM is realized using registers in the above way, the operation of the time slot interchange units ITC can also be reduced similarly to the channel switching apparatuses shown in FIGS. 1 and 4.

That is, a DRAM can be used as a memory, or a DRAM, which is generally damageable, can be a register, and thus improving parts reliability.

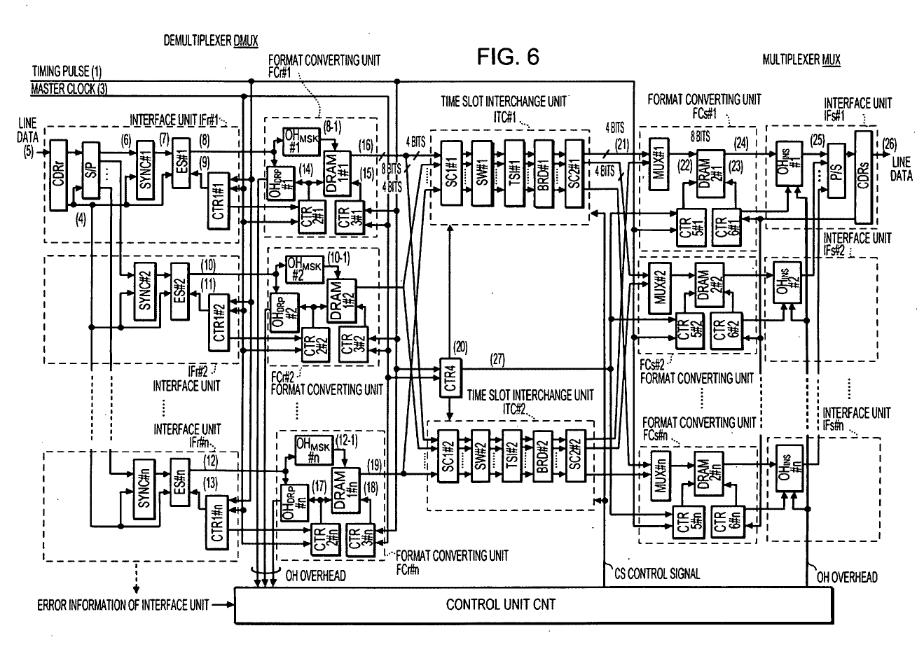

For a channel switching apparatus shown in FIG. 6, overhead mask units OHMSK#1 . . . OHMSK#n are inserted into routes to input input data (8), (10) to (12) to DRAM1#1 to DRAM1#n in format converting units FCr#1 to FCr#n.

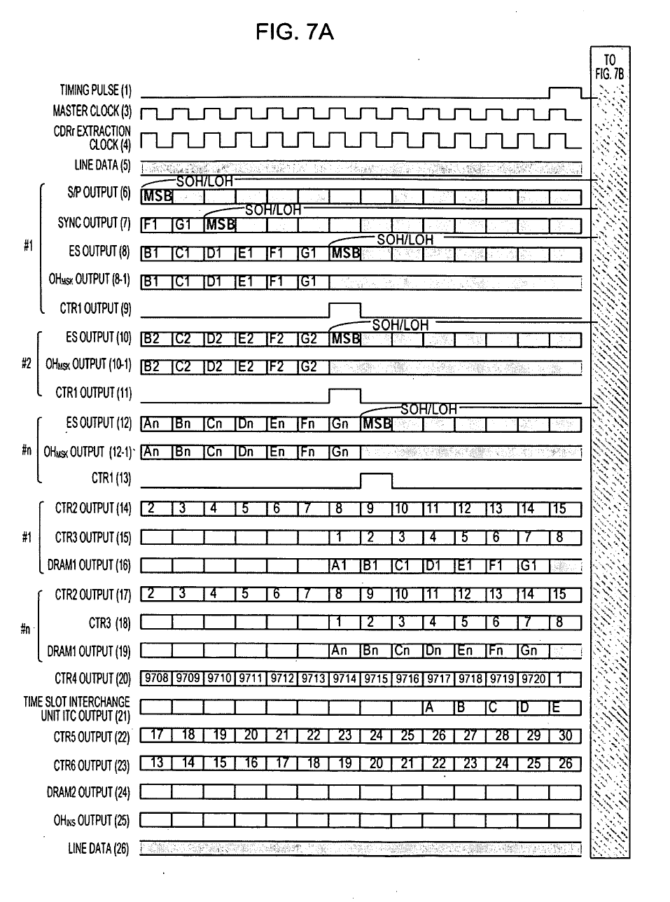

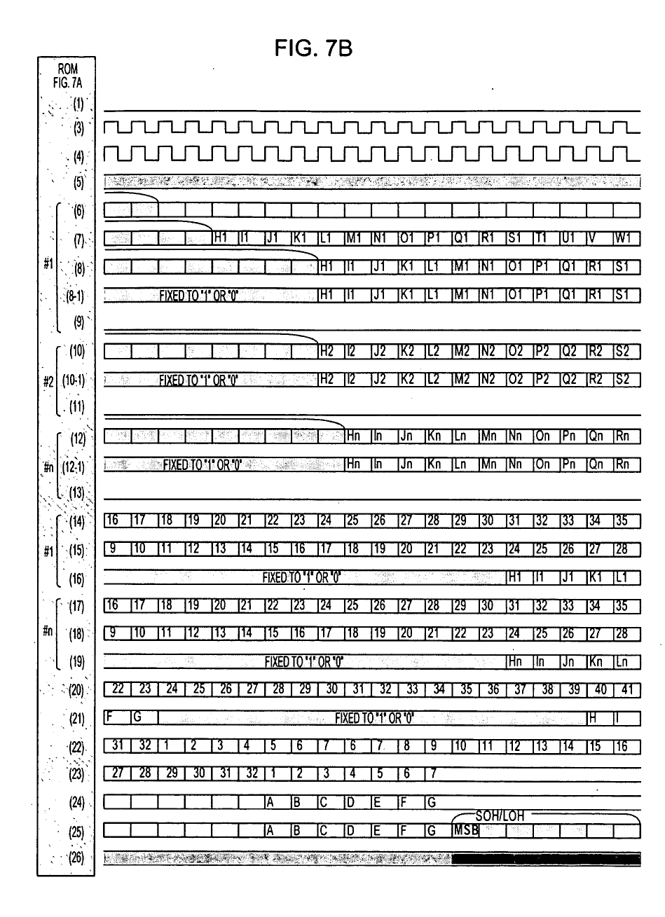

FIGS. 7A and 7B are a timing chart showing the operation of the channel switching apparatus shown in FIG. 6. In the timing chart shown in FIGS. 7A and 7B, the operation of data (6) to (13) is similar to the timing chart shown in FIGS. 2A and 2B.

In FIG. 6, in the format converting unit FCr#1, an overhead branching unit OHDRP#1 outputs extraction and alarm information of pointer data of overheads to a control unit CNT similarly to the channel switching apparatus in FIG. 1, and the data (8) is also sent to the overhead mask unit OHMSK#1. The overhead mask unit OHMSK#1 converts an SOH/LOH region of overhead to data (8-1) fixed to “1” or “0” and outputs the result to the DRAM1#1.

Similarly, in the format converting unit FCr#2, the overhead mask unit OHMSK#2 fixes overheads (SOH/LOH) of the input data (10) to data (10-1) being “1” or “0” and outputs the result to the DRAM1#2. Similarly, in the format converting unit FCr#n, the overhead mask unit OHMSK#n converts the input data (12) to data (12-1) and outputs the result to the DRAM1#n.

Afterward, the DRAM1 store the data (8-1), (10-1) to (12-1) according to the write address signal (14) generated by counters CTR2, read out the data (16) using read address signals (15) to (18) generated by a counter CTR3#1 and concurrently output the data (16) to the time slot interchange units ITC#1 and ITC#2. The operation is similar to the operation of the prior art shown in FIGS. 13 and 14.

The counter CTR4 generates the count signal (20) for the time slot interchange units ITC#1 and ITC#2 according to a timing pulse (1) and a master clock (3). For example, the signal may be a 1/9720 frequency division signal according to the frame length.

The time slot interchange units ITC#1 and ITC#2 perform time slot interchange using the count signal (20) and a control signal CS from the control unit CNT, and output the data (21) to the format converting units FCs.

In the format converting units FCs, a multiplexer MUX multiplexes the data (21) from the dual-system time slot interchange units ITC#1 and ITC#2, and writes the results in the DRAM2 according to the write address signal (22) generated by a counter CTR5. The write address signal (22) here is generated based on a count signal (27) and the timing pulse (1) corresponding to the speed of the master clock (3) generated by the counter CTR4.

A counter CTR6 generates a read address signal (23) based on a line clock generated by clock data recovery unit CDRs and provides the signal to the DRAM2, so that the DRAM2 output the data (24) to an interface unit IFs. Meanwhile, an overhead part fixed to “1” or “0” is rewritten to SOH/LOH data through overhead data from the control unit CNT.

Interface units IFs input the output data (25) of an overhead insertion unit OHINS to a parallel-serial converting unit P/S in each channel in parallel, serially convert the data, provide the result to the clock data recovery unit CDRs, perform level conversion, and output the data as the line data (26).

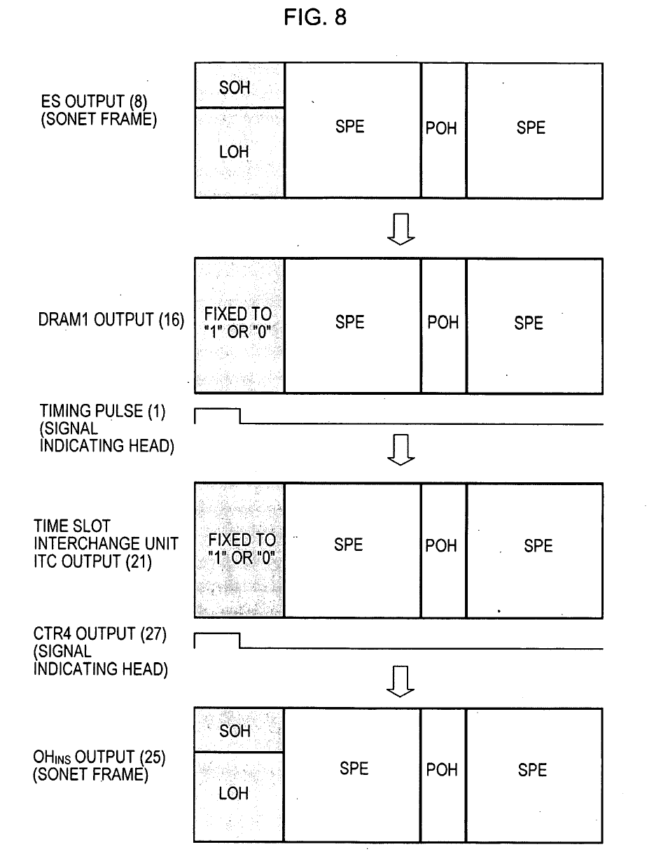

FIG. 8 is a diagram showing a flow of a frame format in the channel switching apparatus shown in FIG. 6. As shown in FIG. 8, the output data (8) of the memories ES has a format of a SONET frame. When the SONET frames are stored in the DRAM1, overheads of the SONET frames are fixed to “1” or “0” and the frames are subjected to time slot interchange by time slot interchange units. However, the frames are returned to the original SONET

frames for output while passing through the format converting units FCs and the interface units IFs. As such, the operation efficiency of the processing in the time slot interchange units ITC decreases, thus reducing the power consumption.

That is, since primary signal data input to a time slot interchange unit contains an overhead, the clock speed cannot decrease as in the channel switching apparatus in FIG. 1, but the data change rate of a TSI unit can be reduced by 0.966 times. As such, the internal operation variation decreases, so that the power consumption can be reduced.

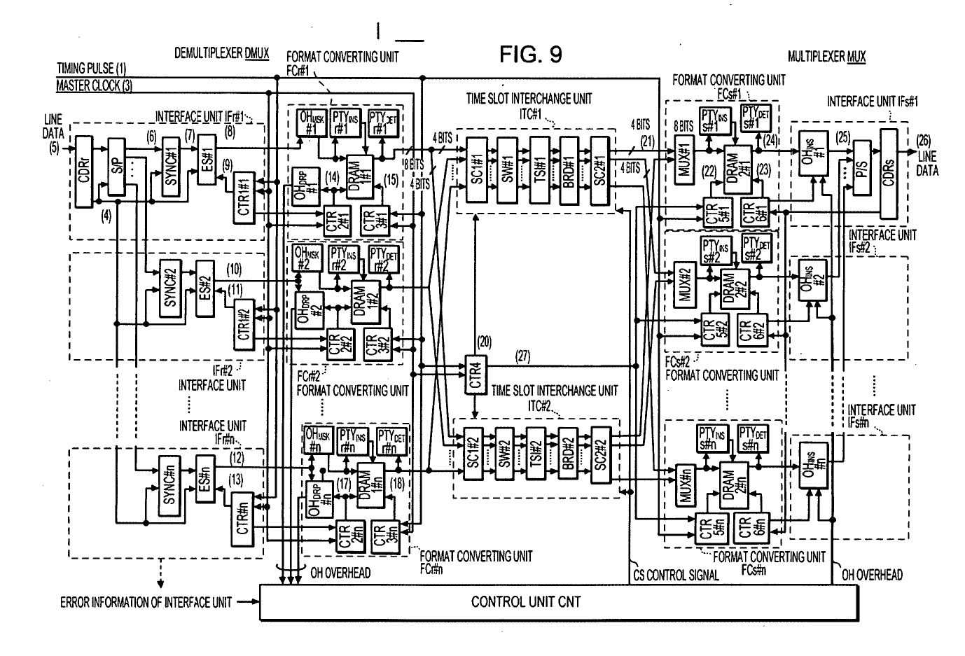

A channel switching apparatus shown in FIG. 9 includes parity insertion units PTYINSr#1 to PTYINSr#n and parity error detection units PTYDETr#1 to PTYDETr#n in format converting units FCr#1 to FCr#n, respectively, and parity insertion units PTYINSs#1 to PTYINSs#n and parity error detection units PTYDETs#1 to PTYDETs#n in format converting units FCs#1 to FCs#n, respectively. A relation between the channel switching apparatus shown in FIG. 9 and the channel switching apparatus shown in FIG. 6 is similar to the relation between the channel switching apparatus shown in FIG. 4 and the channel switching apparatus shown in FIG. 1.

Through a fault diagnosis of a memory used for format conversion, parts reliability and data reliability are improved, and the distribution of improper data to another slot in time slot interchange by a time slot interchange unit may be controlled.

The operation of the channel switching apparatus shown in FIG. 9 is similar to the timing chart shown in FIGS. 7A and 7B, and a flow of a frame format in the channel switching apparatus shown in FIG. 9 is similar to that shown in FIG. 8.

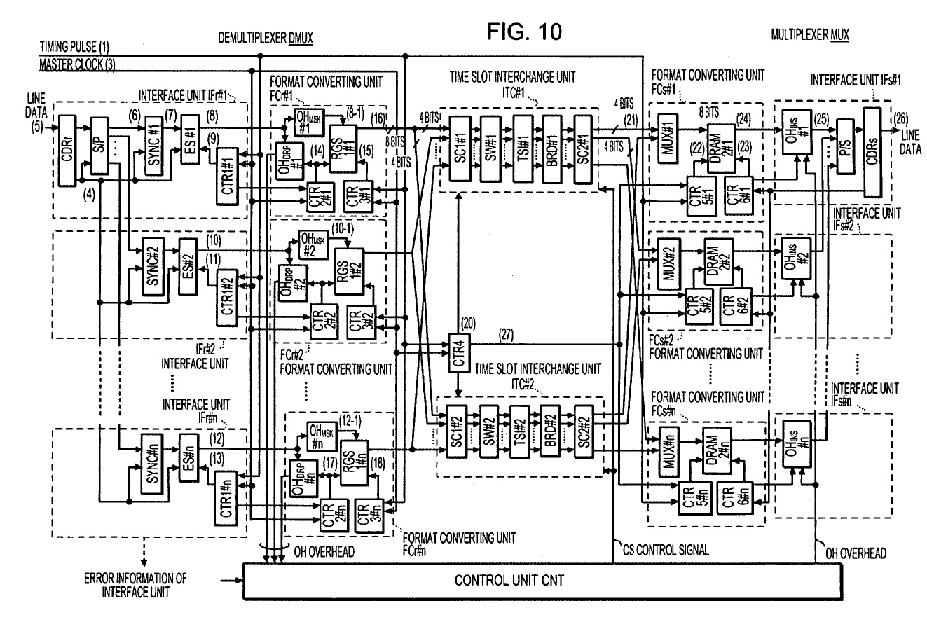

A channel switching apparatus shown in FIG. 10 comprises registers RGS1 (RGS1#1 to RGS1#n) in format converting units FCr and registers RGS2 (RGS2#1 to RGS2#n) in format converting units FCs. For the channel switching apparatuses shown in FIGS. 6 and 9, the DRAM1 in the format converting units FCr correspond to the registers RGS1, and the DRAM2 in the format conversion unit FCs correspond to the registers RGS2.

Since the DRAMs of the channel switching apparatus shown in FIG. 10 are realized in registers, the timing chart and the flow of a frame format are similar to FIGS. 7A, 7B and 8, so that the operation of the time slot interchange units ITC can be decreased similarly to the channel switching apparatuses shown in FIGS. 6 and 9.

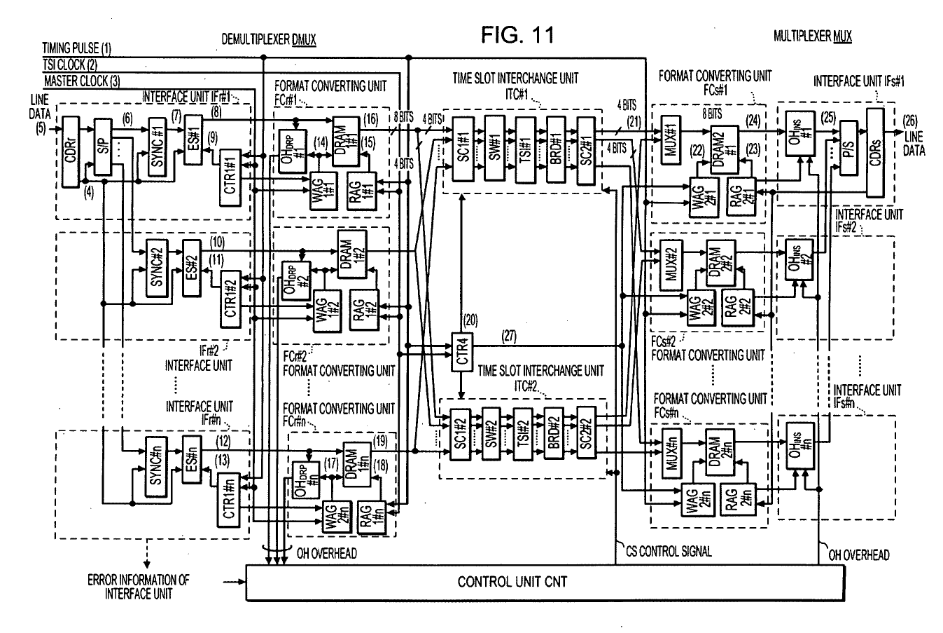

FIG. 11 is a diagram showing configuration in which the channel switching apparatus shown in FIG. 1 is applied to an STS switch fabric. Comparing the configuration in FIG. 11 to the configuration in FIG. 1, write address generation units WAG1#1 to WAG1#n are used instead of the counters CTR2, and read address generation units RAG1#1 to RAG1#n are used instead of the counters CTR3. In the format converting units FCs, write address generation units WAG2#1 to WAG2#n are used instead of the counters CTR5, and read address generation units RAG2#1 to RAG2#n are used instead of the counters CTR6.

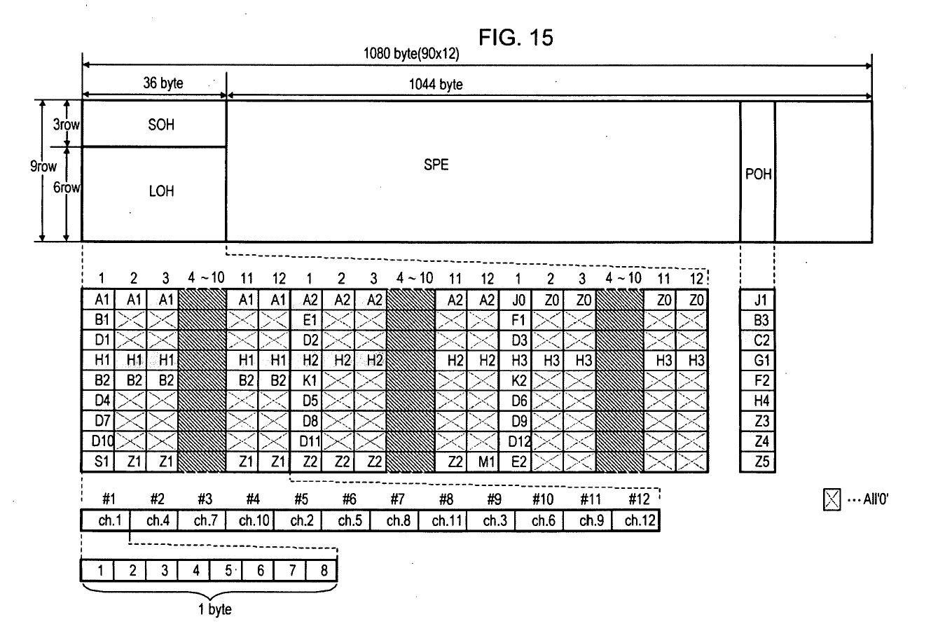

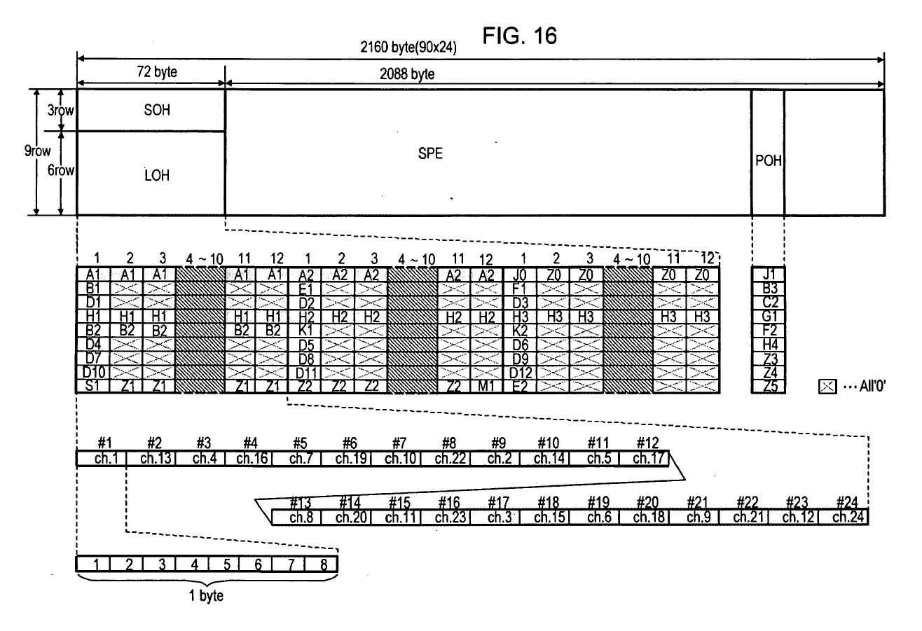

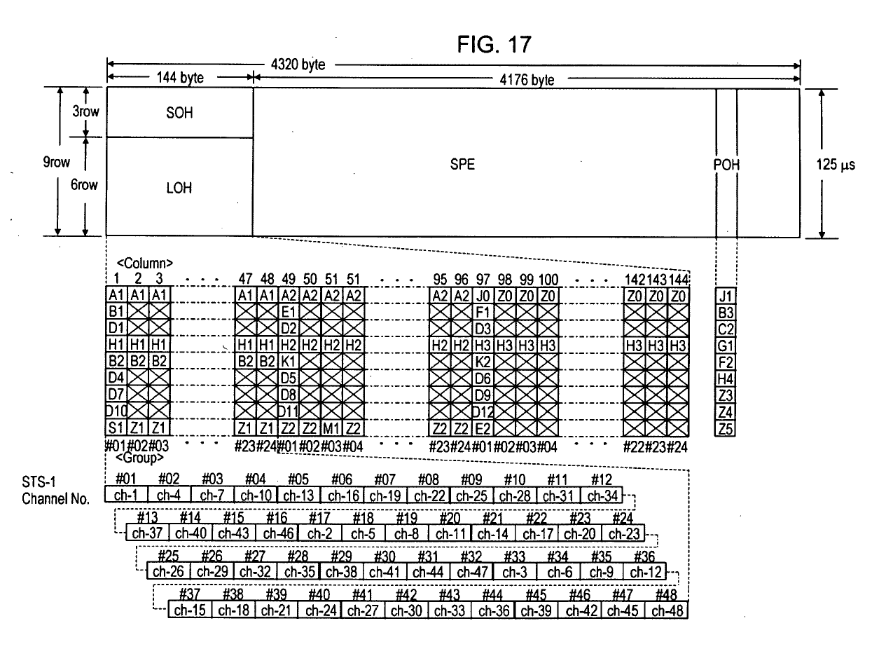

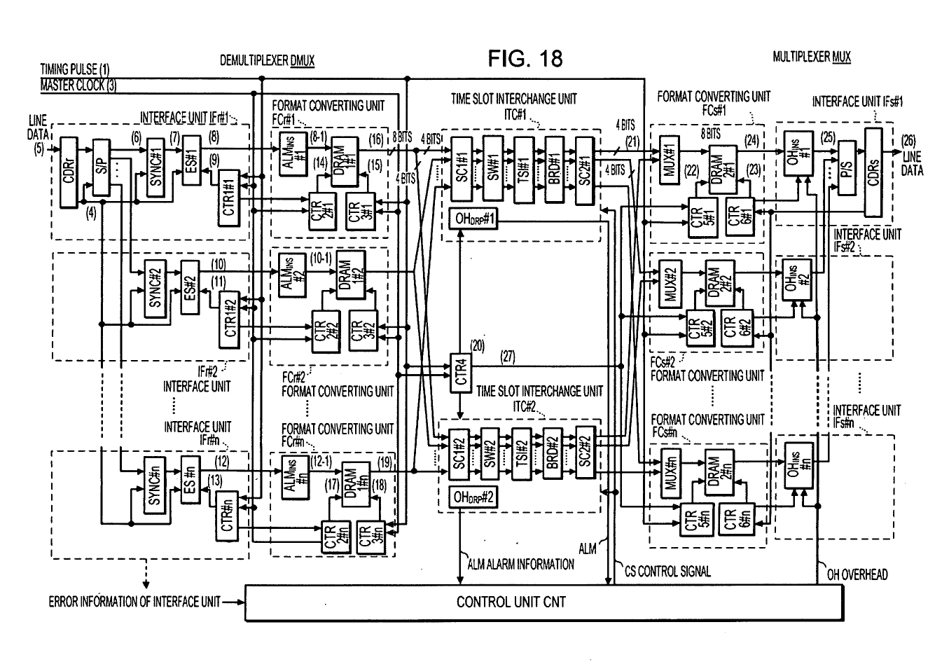

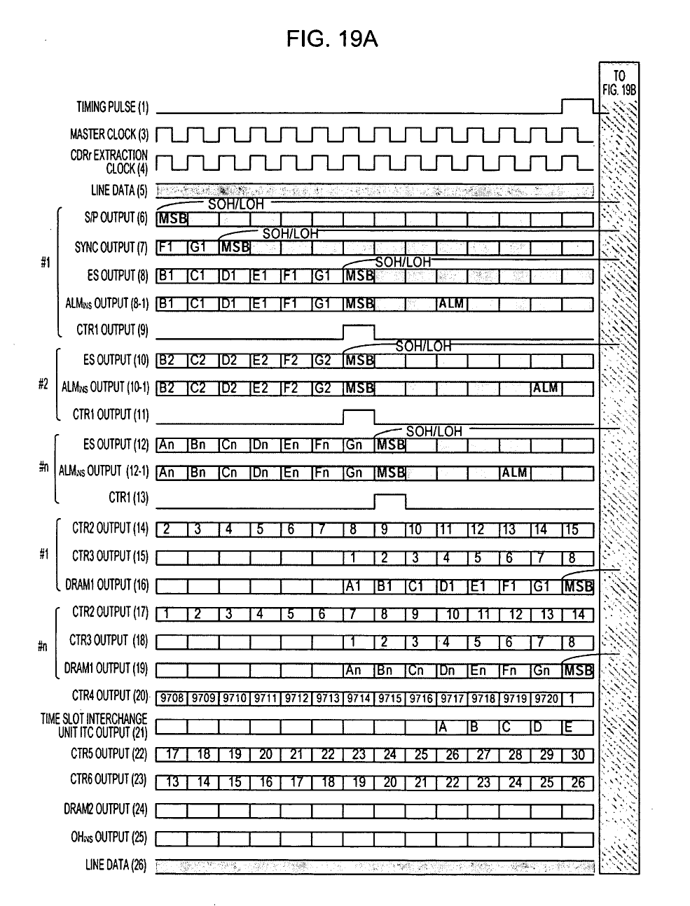

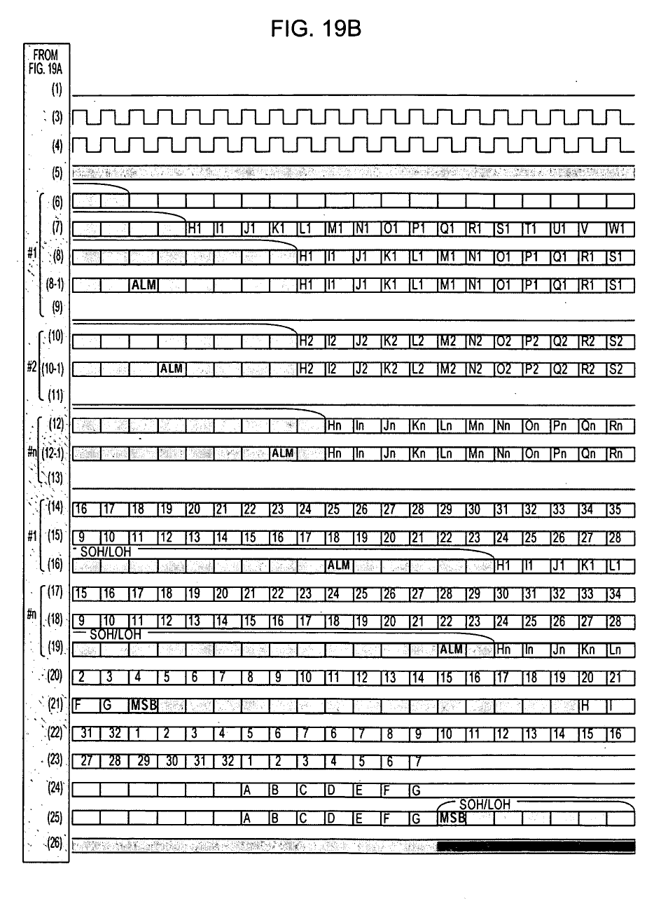

The operation of the STS switch fabric shown in FIG. 11 will be described below using the example of an input signal in an STS-12 frame format shown in FIG. 15.

First, the interface units IFr perform operations similarto the above embodiments. In the format converting units FCr, the overhead branching units OHDRP extract overheads (SOH/LOH) in an STS-12 frame for each channel and send the overheads to the control unit CNT.

In the DRAM1#1, the write address generation units WAG1 write data (8) in the DRAM1#1 using an address signal (14) generated at a speed of 77.76 MHz. Meanwhile, no write address is issued on SOH/LOH timings. The read address generation unit RAG1#1 issues a read address signal (15) according to a timing pulse (1) on a 75.168 MHz clock timing, and reads out payload data only from the DRAM1. The format converting units FCr#2 to FCr#n execute similar processing.

Then, output data from the format converting units FCr is sliced into bits (even number bits/odd number bits), demultiplexed to half data capacities that can be processed by the time slot interchange units ITC, and output to the two time slot interchange units ITC#1 and ITC#2.

The time slot interchange units ITC perform processing such as the processes of slot switching, BLSR, TSI, or bridging using a control signal CS from the control unit CNT in the same way as existing systems. However, SOH/LOH information does not flow into a primary signal of the time slot interchange units ITC. As such, switching is controlled only through software processing by the control unit CNT.

The format converting units FCs bundle data from the two time slot interchange units ITC#1 and ITC#2 into 8-bit byte data, and write the byte data in the DRAM2 according to a write address signal (22) generated by write address generation units WAG2#1 to WAG2#n using the timing pulse (1) indicating the head of a frame from the time slot interchange units ITC. The DRAM2 read out data (24) from the DRAM2 according to a read address signal (23) from read address generation units RAG2#1 to RAG2#n.

Meanwhile, the read address generation units RAG2#1 to RAG2#n divide a frequency of a clock from a clock data recovery unit CDRr for each frame, and issue no read address on timings for overheads (SOH/LOH) of a SONET frame. On the SOH/LOH timings for the data (24) read out from the DRAM2, the overhead insertion units OHINS#1 to OHINS#n of the interface units IFs#1 to IFs#n insert overhead data from the control unit CNT. A parallel-serial converting unit P/S performs parallel-serial conversion on data (25) at the line data rate.

As described in the embodiments above, according to the present invention, the operation speed or operation efficiency of a time slot interchange unit (TSI) can be decreased, power consumption can be reduced, and a timing margin in a highly integrated LSI can be improved, thus the degree of LSI integration can be improved and further downsizing of an apparatus can be realized.

Moreover, line setting and line switching of a time slot interchange unit can be controlled only by software, thereby realizing a general-purpose TSI.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A data processing method comprising:
inputting a signal data with a plurality of time slots;
demultiplexing the signal data into an overhead and data for each time slot;
retaining the overhead for each time slot;
interchanging the data of different time slots; and
combining the overhead with the interchanged data.

2. The data processing method according to claim 1, wherein:
operation of interchanging the data is performed after detecting a parity error of the signal data.

3. A data processing method comprising:
fixing the overhead of a signal data to a constant value;
providing the signal data to a time slot interchange unit that interchanges data of different time slots; and
multiplexing the signal data subjected to the time slot interchange by the time slot interchange unit.

4. The data processing method according to claim 3, wherein:
the time slot interchange is performed after detecting a parity error of the signal data.

5. A data processing apparatus comprising:
an overhead branching unit configured to branch a signal data into an overhead and signal data;
a control unit configured to retain the overhead;
a time slot interchange unit configured to perform time slot interchange on the signal data; and
an overhead insertion unit configured to insert the signal data and the overhead output from the time slot interchange unit and outputting as signal data.

6. The data processing apparatus according to claim 5, wherein:
the time slot interchange is performed after detecting a parity error of the signal data.

7. A data processing apparatus comprising:
an overhead branching unit configured to extract an overhead of a signal data, and to rewrite the overhead of the signal data to a constant value;
a time slot interchange unit configured to interchange data of different time slots of the signal data; and
an overhead insertion unit configured to rewrite an overhead of the signal data output from the time slot interchange unit with the extracted overhead.

8. The data processing apparatus according to claim 7, wherein, the time slot interchange is performed after detecting a parity error of the signal data.
